(19) United States
(12) Patent Application Publication
(10) Pub. No.: US 2011/0297108 A1
(43) Pub. Date: Dec. 8, 2011

(54) Animal Reflective Collar

(76) Inventor: Francisco J. Alvarenga, Visalia, CA (US)

(21) Appl. No.: 12/795,668

(22) Filed: Jun. 8, 2010

(51) Int. Cl. A01K 27/00

(52) U.S. Cl. 119/856

(57) ABSTRACT

My invention relates to pet collars generally. Its object is to improve the safety and utility of pet collars. A further object is to improve the marketability of pet collars. Another object of the collar is to provide enhanced visibility of the pet at all hours of the day and night. The pet collars presently designed are dull, dark and do not provide an enhanced safety feature for dogs.

### BACKGROUND OF INVENTION

1. Field of the Invention

The present invention relates to animal collars; more importantly it relates to collars especially suited for nighttime and dusk hours to provide safety for animals while traversing on the street.

2. Description of Prior Art

Collars come in many different shapes and sizes. There are glittery collars, strong collars and collars for flea protection. Pet protection during the night time hours, however, has not been a priority. The illuminating characteristics of car headlamps provide about 25-50 feet of light. Pets are often not seen when they are running across the street during the night time hours. Several approaches have been attempted at solving this problem. The present invention differs in that it is comprised of an animal collar, made out of any material, that contains reflectors embedded onto the collar itself.

U.S. Pat. No. 6,925,965B1 discloses an Omnidirectional Reflective Pet Leash. This leash however is made of various sheets and contains braided strips. This differs from the present invention in that it does not contain actual reflectors but is comprised of braided strips of fabric.

U.S. Pat. No. 3,871,336 discloses a reflective collar. This collar differs from the present invention in that it contains painted elements instead of the embedding of reflectors on the leash itself. Similarly U.S. Pat. No. 2,721,257 discloses a collar with a light attachment. This includes bulbs and batteries, which require electric operation.

The main object of this invention is to create visibility of animals at all hours of the night and day. The invention accordingly consists in the features of construction, combinations of elements, and arrangement of parts which will be exemplified in the construction hereinafter described, and of which the scope of the application will be indicated in the following claims.

### BRIEF DESCRIPTION OF THE INVENTION

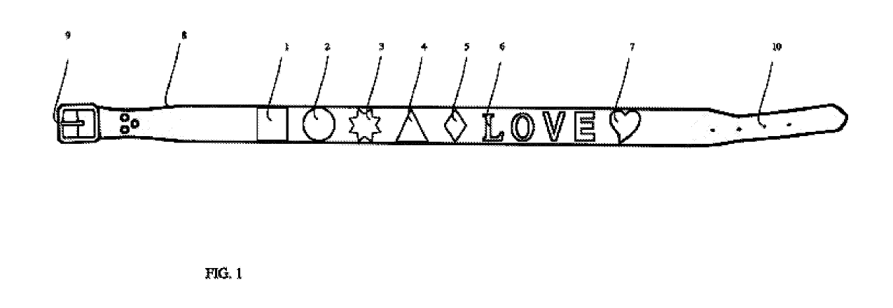

FIG. 1 is a top plan view of the collar;

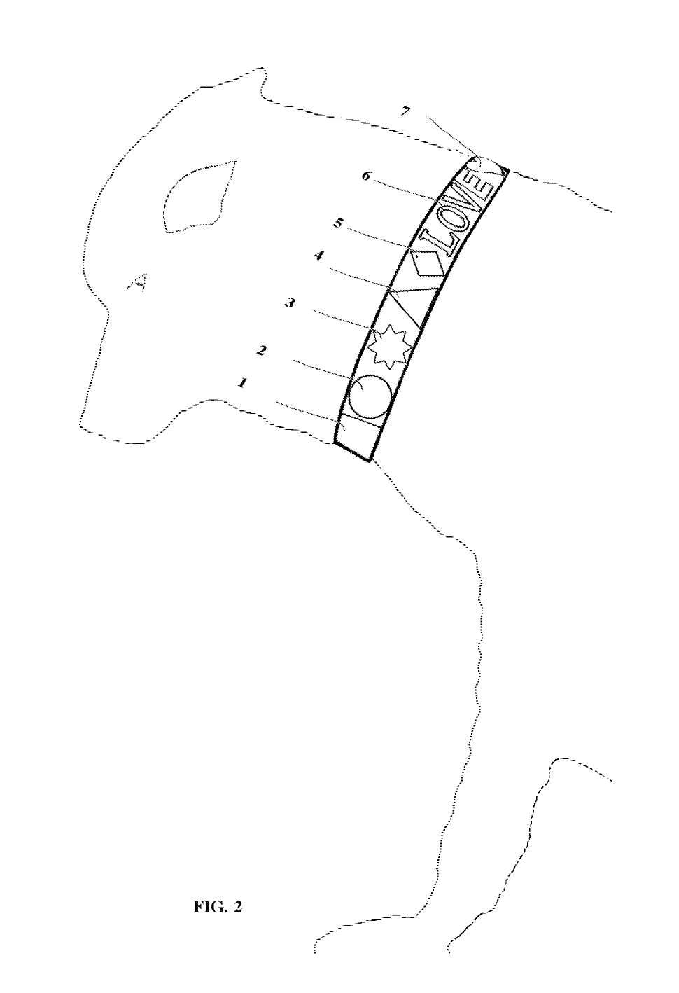

FIG. 2 is a perspective view of a dog wearing the collar embodying the features of the invention

### DETAILED DESCRIPTION

As shown in FIGS. 1 and 2 the invention is comprised of a collar base 8 made out of leather, imitation leather, plastic, nylon, or other flexible material and a buckle 9. The base 8 of said collar contains a plurality of reflector materials 1,2,3,4,5,6,7 which sparkle and reflect when being hit by light. To achieve a better reflective and decorative effect the reflectors of said collar can be comprised of different shapes and colors or consecutive shapes and colors. The embodiment shown, element 1 is square, 2 is round, 3 is star, 4 is triangular, 5 is diamond, 6 is letters, and 7 is heart shaped. Similarly, alternate elements can have different colors and forms, including letters. The reflectors 1,2,3,4,5,6,7 are embedded on the collar base 8. A buckle 9 is provided on the collar so to allow it to be fastened to secure the base 8 in place around the animal's body. The base 8 is also comprised of varying number of holes provide a securing means of the base 8 around the animal's body.

The collar lends itself to many variations. Different shape and color schemes can be used. As various embodiments may be made of the above invention, it is understood that all matter herein set forth or shown in the accompanying drawings is to be interpreted as illustrative and not in a limiting sense.

I claim:

1. An Animal Collar comprising, in combination, of a collar-encircling flexible base member made out of leather, imitation leather, plastic, nylon or other flexible material and a fastener or buckle to secure the collar in place around the animal's body and wherein reflectors are embedded into the base.

2. Said Collar of claim 1 wherein the reflectors embedded therein are comprised of different colors in combination or of the same color consecutively placed

3. Said Collar of claims 1 and 2 wherein the reflectors embedded therein are comprised of different shapes in combination or of the same shape consecutively placed
